(19) United States
(12) Patent Application Publication
(10) Pub. No.: US 2024/0303511 A1
(43) Pub. Date: Sep. 12, 2024

(54) NETWORK TRAFFIC FLOW CLASSIFICATION USING FULLY SEGMENTED MODELS

(71) Applicant: Hewlett Packard Enterprise Development LP, Spring, TX (US)

(72) Inventors: MADHUSOODHANA CHARI SESHA, Bangalore (IN); Ramasamy Apathotharanan, Bangalore (IN); Sumangala Bannur Subraya, Bangalore (IN); Madhumitha Rajamohan, Bangalore (IN); Azath Abdul Samadh, Bangalore (IN); Chirag Dineshkumar Shah, Bangalore (IN)

(21) Appl. No.: 18/179,137

(22) Filed: Mar. 6, 2023

(51) Int. Cl. G06N 5/025; G06F 18/24; H04L 43/026

(52) U.S. Cl. CPC G06N 5/025; G06F 18/24765; H04L 43/026

(57) ABSTRACT

Systems and methods are provided for classifying network traffic flows across a network. Specifically, the network traffic flows are classified under a fully-segmented ruleset, wherein the fully segmented ruleset was generated by training a decision tree machine learning (“ML”) algorithm with a training dataset, and wherein each item of the training dataset satisfies the complete rule pathway to different leaf nodes of the fully segmented ruleset. Classification under a fully-segmented ruleset allowing for capture of idiosyncratic patterns specific to a given malicious source of network traffic flows. Further, systems and methods are provided allowing for a user to designate network traffic flows for classification of network traffic flows at different network devices, wherein the classification at different network devices may allow for more computationally intensive classification.

### BACKGROUND

Classification of network traffic is helpful to network management. Such classifications enable network administrators (“admin users”) to better understand what various flows across the network are doing and how these flows behave. With these classifications, admin users may make better decisions regarding which policies to enforce on the network to improve the network's performance (e.g., prevent malicious traffic flows, improve responsiveness of the network, improve data transfer rates).

As traffic flows get faster and grow more complex, machine learning (“ML”) algorithms have been employed to assist in the classification of traffic flows. One such ML algorithm is the decision tree ML algorithm. Decision tree ML algorithms are trained on pre-labeled training data to generate rulesets. An example of pre-labeling applied to training data may include, e.g., labeling traffic flow metadata relating to traffic flows originating from a device streaming video as “video streaming” while labeling traffic flow metadata relating to traffic flows originating from a server hosting a website as “website host”.

The ruleset generated by training an ML algorithm with pre-labeled data may be subsequently applied to a set of unlabeled data (“test data”) to assign labels to the test data. In the common use case, the labels applied to test data correlate with one or more patterns present in the labeling of the training data. In the context of network traffic flows, rulesets can be generated from sets of pre-labeled network traffic flows. These rulesets can then be employed to apply labeling to incoming network traffic flows. In this sense the pre-labeled network traffic flows are the training data, and incoming network traffic flows are test data. Where the labeling is applied to the incoming network traffic flows, such incoming network traffic flows can be said to be classified according to patterns in the pre-labeled network traffic flows.

### BRIEF DESCRIPTION OF THE DRAWINGS

The present disclosure, in accordance with one or more various examples, is described in detail with reference to the following figures. The figures are provided for purposes of illustration only and merely depict typical or example embodiments.

FIG. 1 illustrates a network fabric in which examples of the technology disclosed herein may be implemented.

FIGS. 2A-2C illustrate an example fully-segmented decision tree ruleset and how it relates to a training dataset which was used to train the generating decision tree ML algorithm.

FIG. 3 illustrates an example generating device employing systems and methods to classify traffic flows across a network according to a fully segmented model, in accordance with examples of the present disclosure.

FIG. 4 illustrates an example deploying device employing systems and methods to classify traffic flows across a network according to a fully segmented model, in accordance with examples of the present disclosure.

FIG. 5 is an example computing component that may be used to implement various features of examples described in the present disclosure.

The figures are not exhaustive and do not limit the present disclosure to the precise form disclosed.

### DETAILED DESCRIPTION

In the context of classifying network traffic flows according to maliciousness, pre-existing training datasets may be compiled which include traffic flow data relating to various malicious sources (e.g. malware programs) that have been labeled as “non-benign.” Also in such training datasets, non-malicious traffic flow data may be labeled as “benign”. Often, such training datasets contain complex traffic flow patterns relating to specific malware programs.

For instance, a malware program from the year 2000, the “ILOVEYOU” worm, may generate traffic flows which follow unique and repeated patterns due to the specific instructions making up the ILOVEYOU worm. In addition to the ILOVEYOU worm, traffic flows originating from the “Mydoom” worm of 2004 may appear in the same training dataset. Due to the difference in authorship of the instructions making up these worms, traffic patterns generated by the ILOVEYOU worm may have little in common with the Mydoom worm. In more abstract terms, idiosyncrasies specific to each of the multiple malware programs, known and unknown, that may make up a training dataset in this context result in training datasets which may contain little if any generalizable large scale (e.g., dataset spanning) patterns. On top of that what generalizable large scale patterns do appear may be unrelated to the maliciousness of the traffic flows, as it may not originate from the malicious programs underlying the training datasets. Put another way, in the context of classifying network traffic flows according to maliciousness, small scale patterns may be more informative than large scale patterns.

Further, such idiosyncrasies in training datasets may later show up in real-world traffic flows because malware programs often continue to propagate themselves long after being identified as malware. For example, the patterns specific to Mydoom worm of 2004 may reappear, despite it being identified as malware for over 10 years, because someone connected an infected machine to a network with outdated malware detection. This presents an additional situation wherein detecting small scale patterns is important, as it will more readily detect traffic a reemergence of known malware programs.

By contrast, focusing on large scale patterns would effectively be looking for characteristics shared across all malicious traffic, past and present, based on shared characteristics between known and unknown originating malware programs. These patterns are likely to be weak if at all apparent, partly because those that write malicious programs may intentionally avoid commonalities with older malicious programs that have already been identified as malicious. In addition, large scale patterns between traffic flows originating from malware programs may appear for benign reasons, i.e., a shared country of origin of multiple malware authors, a shared language of the multiple malware authors. Association of such benign large scale patterns with malicious traffic may lead to reduced classification accuracy.

Decision tree ML algorithms have the capability to generate rulesets capturing both large scale generalized patterns and narrow complex patterns within a training dataset. However, it is sometimes the case that both large scale generalized patterns and narrow complex patterns cannot be captured in the same generated ruleset. This phenomenon is understood by one of skill in the machine learning context, as the bias-variance tradeoff. This tradeoff can be said to arise from the inherent limitation on any real system (e.g., an ML algorithm) to achieve only so much combined accuracy and precision in accomplishing its goals (e.g., capturing patterns)

Hyperparameters affect the location of an ML algorithm's ability to capture patterns along this bias-variance tradeoff. An admin user or system designer may adjust hyperparameters to change the type of patterns captured in rulesets generated by training the ML algorithm. For instance, in the decision tree ML algorithm context, the maximum depth, maximum/minimum leaf size, and maximum/minimum features considered may all be hyperparameters. Changing these hyperparameters will affect whether rulesets generated by the decision tree ML algorithm capture large scale patterns common across the entire training dataset or small scale patterns unique to sources of labeling within the training dataset (e.g., the ILOVEYOU worm, the Mydoom worm).

As discussed above regarding the ILOVEYOU and Mydoom worms example, when dealing with training sets labeling data according to maliciousness, the importance of capturing narrow complex patterns may outweigh the importance of capturing broad generalized patterns. As such, the present disclosure contemplates using decision tree ML algorithms on training datasets wherein the decision tree ML algorithm's hyperparameters are set to maximize the capture of narrow complex patterns, e.g. to skew to the extreme variance end of the bias-variance tradeoff. A ruleset generated by such hyperparameter settings is referred to herein as “fully segmented”. “Segmentation” in the context of decision tree ML algorithms refers to the number of items within the training dataset per “leaf” of rulesets generated by training the decision tree ML algorithm. A leaf refers to a unique suite of features of an item in the training data that justifies a labelling designation. A “fully-segmented ruleset has only one training dataset item satisfying any given leaf.

Notably, fully segmented rulesets are generally avoided in common ML practice, as such rulesets are said to be “over-fitted” to the training data. Over-fitted rulesets refers to rulesets skewed to the variance side of the bias-variance tradeoff, and are commonly avoided for being sensitive to small changes (e.g., noise) in the features of given item of test data. Such concerns are avoided here where the training dataset is expected to contain idiosyncratic and complex patterns (e.g., the unique traffic data flow patterns associated with the ILOVEYOU worm and/or unique traffic data associated with other known malware programs), and/or there's cause to expect such idiosyncratic and complex patterns to appear in real-world data (e.g., previously identified malware programs like the ILOVEYOU worm may still reemerge). Sensitivity to small changes in test data features are required to detect these complex idiosyncrasies. This means that aspects of the present disclosure may be readily adapted to other areas of ML applications wherein training datasets share similar expectations. Finally, this highlights some of the improvements of the disclosed invention: idiosyncratic and complex patterns expected to recur in real-life network traffic data are better captured, resulting in more informative displays for admin users and consequently better management directives regarding malicious network traffic.

In some cases, training datasets may be encountered wherein training a decision tree ML algorithm with the training dataset will not generate a fully segmented ruleset, regardless of hyperparameter settings. For instance, where two items of traffic flow metadata contain identical features but are pre-labeled differently, generation of a fully segmented ruleset may be impossible. Where generation of a fully segmented ruleset is impossible, the disclosure contemplates modifying the training dataset (e.g., removing troublesome training dataset items) until a fully segmented ruleset may be achieved. Once a fully segmented ruleset is achieved, leaves within the ruleset may be identified for flagging according to a flagging strategy, and then the ruleset and flagging strategy may be deployed to a network device. “Flagging strategies” refers to methods for designating traffic flows which are in need of more computationally intensive classification.

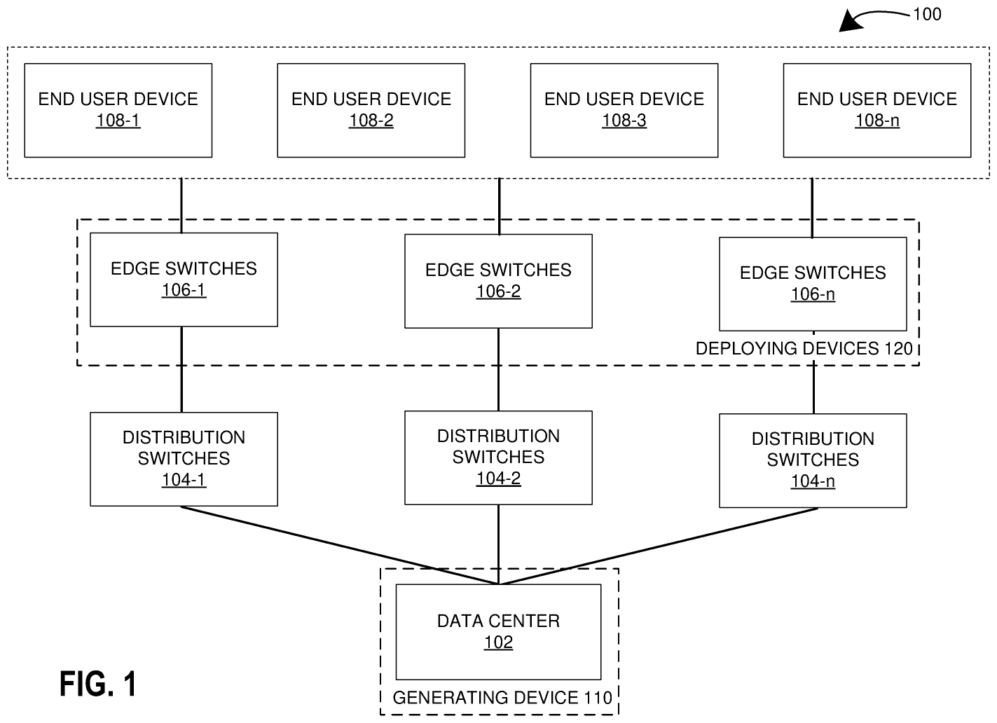

In some examples, the network device where the ruleset is generated (“generating device”) and the network device where the ruleset is deployed (“deploying device”) are different devices. The disclosed example network below (see FIG. 1) contains a centralized network device (e.g. a data center or cloud service) comprising greater hardware resources (e.g., processing power, memory) when compared with other network devices (e.g. edge switches, end user devices, distribution switches). The disclosure herein describes the generating device as a centralized network device because such devices sometimes contain adequate resources for running decision tree ML models and storing training datasets. The fully segmented ruleset is then deployed at the deploying device (disclosed herein as an edge or distribution switch) for classification of network traffic flows passing through the deploying device. The generated ruleset may be run on the network devices containing less hardware resources because the generated ruleset may be simpler than the ML algorithm that generated it. In other examples, the generating device and the deploying device may be the same device. In some examples, the generating device may have lesser hardware resources than a deploying device. In some examples, the deploying device may have greater hardware resources than another networked device.

Once the fully segmented ruleset and flagging strategy have been deployed to the deploying device, the deploying device classifies network traffic flows according to the fully segmented ruleset. Where network traffic flows are flagged according to the flagging strategy, metadata describing features of the network traffic flow (“flagged metadata”) are sent to a network device. In the disclosure herein, the network device receiving the flagged metadata is the generating device. In some examples the network device receiving the flagged metadata is not the generating device. In some examples, the network device receiving the flagged metadata is the deploying device.

After the flagged metadata is received at the network device, a ruleset generated by training the ML algorithm on the unmodified training dataset (e.g., a version of the training dataset without the troublesome training dataset items removed) may be applied to classify the traffic flows associated with the flagged metadata. In some examples, the flagged metadata may be classified by comparing the features of the flagged metadata directly with the features of an item of the training dataset. For instance, the difference between the flagged metadata's packet size and the packet size of the closest item of the training dataset may be measured. Where the difference is below a threshold, the flagged network traffic flow is labeled with the label applied to the closest item of the training dataset. Where the difference is above a threshold, the flagged network traffic flow data is labeled as unknown. In some examples, multiple features may be compared simultaneously based on a Euclidean distance between the multiple features of the flagged metadata and the multiple features of the closest item of the training dataset.

With the network traffic flows labeled according to the disclosed systems and methods, a network administrator may more effectively manage the network and/or identify and respond to malicious traffic flows. In some examples, actions taken by the system, such as hyperparameter tuning or flagging strategy designation, may be taken by a user (e.g., an admin user) in response to options presented on a graphical user interface (e.g., a GUI) at a network device. In some examples, the GUI may be presented to an admin user at a first network device, but the actions taken result in the execution of instructions on a second network device, such that the user may manage the network traffic flows from any device on the network.

The present disclosure relates to tools which may assist admin users in better understanding traffic flows on the networks they manage. Though this disclosure is described in the context of classifying traffic flows according to the maliciousness of the transferred data, the disclosed systems and methods may be applied to any network traffic flow classification scheme. Malicious data is described herein based on the purpose and/or source of the data. For example, data may be labeled “non-benign” where the data originated from a malware program, and data may be labeled “benign” where the data relates to an email between credentialed users. “Training data” in the present disclosure refers to traffic flow metadata (metadata being data describing features of the flows) that is pre-labeled. “Features” in the present disclosure refers to various metrics of a data flow which may be detected by a device through which the data flow passes, e.g., inter-packet arrival time, session timeout, burst duration, flow size distribution, estimated cardinality. Alternative classification schemes for network data may include, e.g., FTP vs. HTTP, live vs. pre-recorded data, encrypted vs. non-encrypted. Further, aspects of the disclosure may be applied to classify data outside the context of computer networks (e.g. medical diagnoses, automobile traffic flows, computer vision).

FIG. 1 illustrates a network fabric 100 in which examples of the technology disclosed herein may be implemented. The network fabric 100 is provided for illustrative purposes only and should not be interpreted as limiting the scope of the technology only to the depicted network fabric topology. The technology disclosed herein is agnostic to the network topology implemented. A person of ordinary skill in the art would understand that the technology disclosed herein is applicable within any communications network regardless of the network topology implemented. As shown in FIG. 1, the example network fabric 100 may include a data center 102. In various examples, the data center 102 may include one or more servers or other computing resources. Although depicted as a single entity in FIG. 1, the data center 102 may comprise a plurality of geographically distributed servers configured to provide the core functionality for a network implementing the network fabric 100. In various examples, the data center 102 may provide cloud-based services to a number of end user devices 108.

The network fabric 100 may be configured to provide flows to and from the data center 102 and a plurality of end user devices 108-1 to 108-n (collectively, “the end user devices 108). The end user devices 108 may comprise one of a plurality of different computing devices, including but not limited to smart phones, laptops, desktops, smart watches, modems, Internet phones (facilitating Voice Over IP (VOIP)), printers, tablets, over the top (OTT) media devices (e.g., streaming boxes), among other devices. In various examples, the end user devices 108 may include one or more Internet of Things (IoT) devices, such as connected appliances (e.g., smart refrigerators, smart laundry machines, etc.), connected vehicles, connected thermostats, among others. A person of ordinary skill in the art would understand the end user devices 108 may cover any connected device that may download and/or upload data through the network fabric 100.

Data may flow between the end user devices 108 and the data center 102 through the distribution switches 104-1 to 104-n (collectively, “the distribution switches 104) and edge switches 106-1 to 106-n (collectively, “the edge switches 106”) of the network fabric 100. The data center 102, distribution switches 104, and edge switches 106 represents different layers of a communications network to which each end user device 108 can connect and communicate. As a non-limiting example, the data center 102 may correspond to the core layer of a network implementing the network fabric 100, the distribution switches 104 may correspond to an intermediate layer of the network (e.g., a “fog” layer), and the edge switches 106 may correspond to an edge layer of the network, the edge corresponding to a geographic boundary of the network implementing the network fabric 100. The distribution switches 104 (also referred to as aggregation switches) represent one or more devices configured to uplink to the core layer and links down to the edge layer devices. The distribution switches 104 function to bridge the core layer and the edge layer, aggregating data flows from the edge switches 106 and forwarding the information to the core layer. In various examples, one or more distribution switches 104 may be directly connected to one or more servers of the data center 102, while in some examples one or more distribution switches 104 may be connected to a core layer switch, which is a high capacity switch positioned between the data center 102 or other devices of the core layer and the rest of the network fabric 100. In various examples, the distribution switches 104 can comprise a switch, hub, router, bridge, gateway, or other networking device configured to connect the core layer with the edge layer of the network fabric 100.

As discussed above, the edge switches 106 may be positioned at a geographic edge of the network fabric 100. Edge switches 106 (also referred to as access switches) provide a point of access for end user devices 108 to connect to the network, and are the only devices of the network fabric 100 that directly interact with the end user devices 108. In various examples, the edge switches 106 can comprise a switch, hub, router, bridge, gateway, or other networking device configured to connect the end user devices 108 with the network fabric 100 and to communicate with the distribution switches 104.

Network traffic classification provides visibility for use in network monitoring, security enhancement, and priority treatment. Current classification approaches may be computationally intensive, and in some cases the edge switches 106 (and, in some cases, the distribution switches 104) lack the amount of computational resources necessary to accurately identify patterns in the traffic flow features. Identification of such patterns may require the employment of a ML algorithm, which may only be feasible at network devices with greater computational resources. For example, once a ruleset has been generated based on the patterns identified by the ML algorithm running at the data center 102, the ruleset may then be deployed to devices with less computational resources, e.g., distribution switches 104, edge switches 106. These distribution switches 104 and/or edge switches 106 are then are able to efficiently classify network traffic flows according to features detected locally without using network resources to send the features to the data center 102 for processing.

In the disclosed network fabric 100, data center 102 acts as the generating device 110, i.e., an ML algorithm may be trained there to generate fully segmented rulesets for classifying network traffic flows. Once the fully segmented rulesets are generated at the generating device 110, they are deployed to deploying devices 120 via transfer over the network. The deploying devices 120 run features of traffic flows passing through the network fabric 100 through the ruleset to classify the network traffic flows as either “benign” or “non-benign,” and in some examples to flag the network traffic flows for further classification at a device with more computational resources. The disclosed network fabric 100 has the edge switches 106 acting as deploying devices 120, however in some examples, the distribution switches and/or data center may act as deploying devices 120. In some examples, any number and combination of devices on the network (e.g., 102, 104, 106, 108) may act as deploying devices. In some examples, there may be more than one generating device 110, and/or there can be any combination of devices on the network (e.g., 102, 104, 106, 108) acting as generating devices.

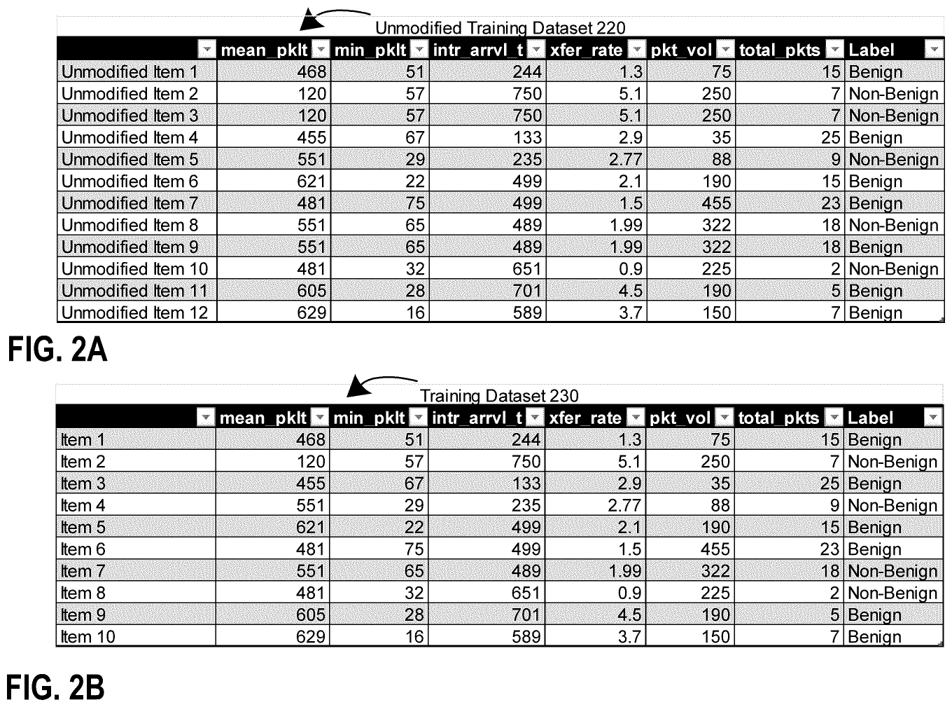

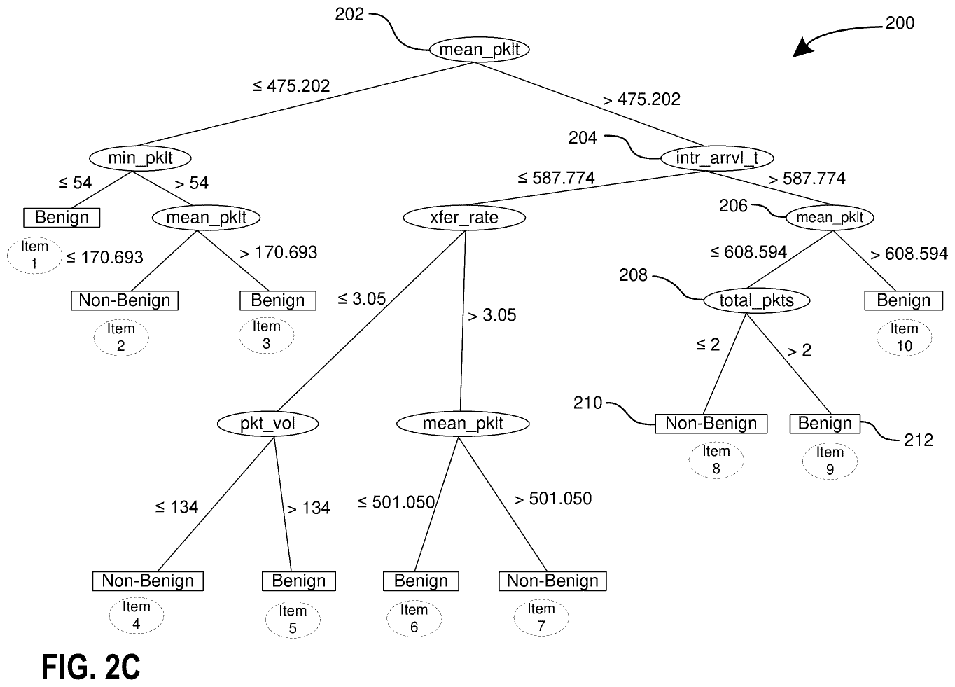

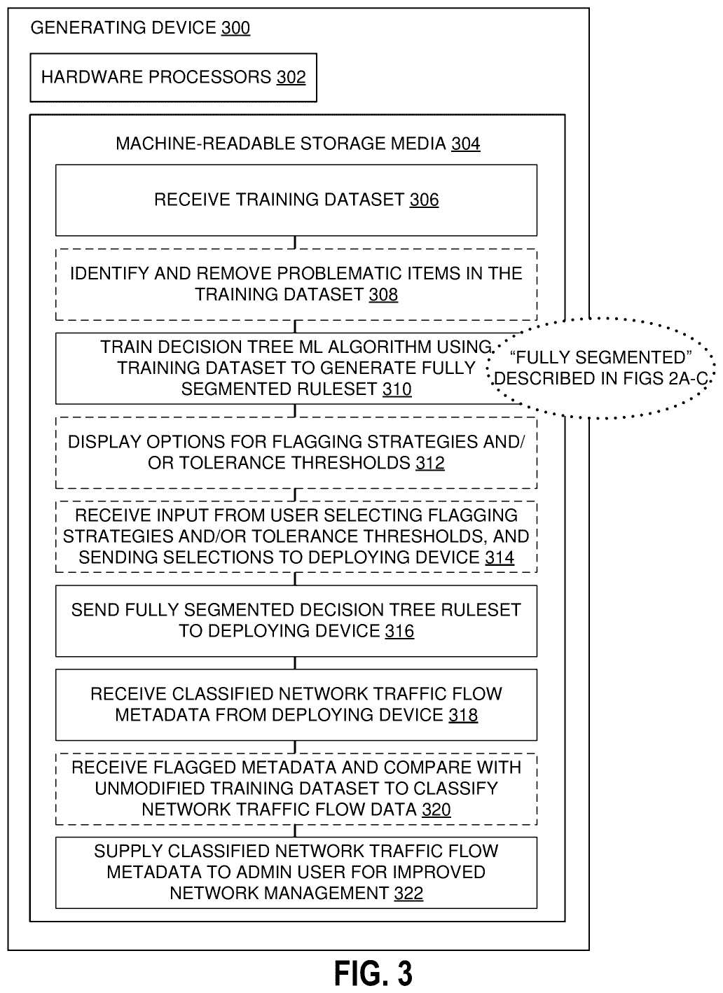

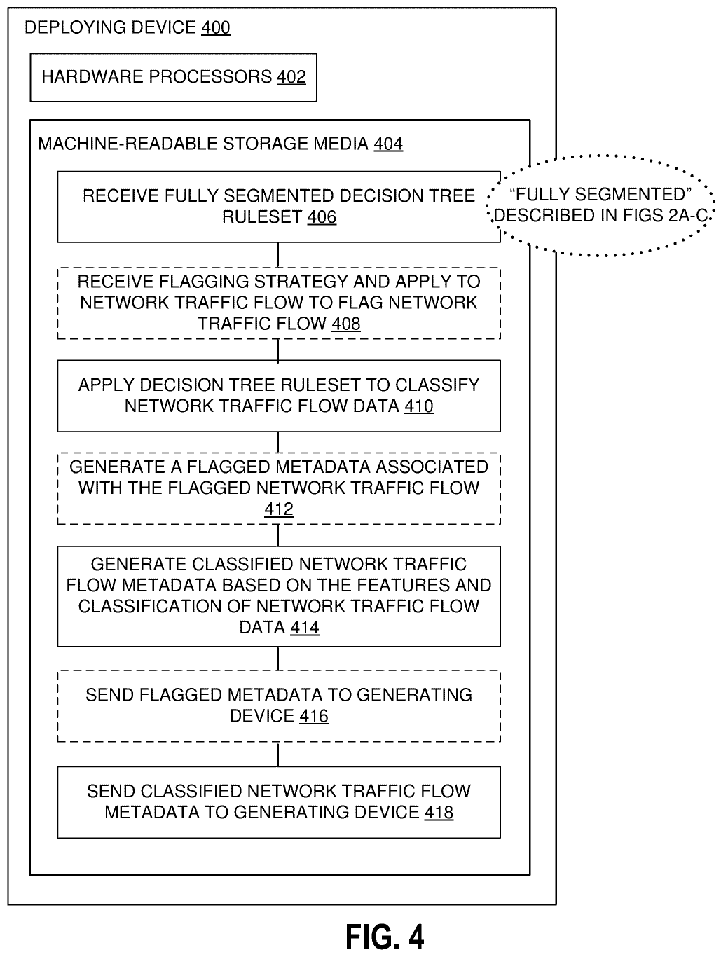

FIGS. 2A-C illustrate an example fully-segmented decision tree ruleset 200 and how it relates to the training dataset 230 which was used to train the generating decision tree ML algorithm. FIG. 2A illustrates an unmodified training dataset 220 contains unmodified item 1-12 with the following features: mean_pklt—the mean length of packets in the traffic data flow, min_pklt—the minimum length of packets in the traffic data flow, intr_arrvl_t—inter packet arrival time, xfer_rate—packet transfer rate, pkt_vol—packet volume, and total_pkts—total transferred packets. Importantly, the unmodified items 1-12 are labeled according to maliciousness of the associated traffic flow, i.e., benign vs. non-benign. Unmodified items 1-12 are referred to as unmodified, because they belong to the unmodified training dataset 220. What makes unmodified training dataset 220 and its items “unmodified” is that the training dataset contains one or more troublesome items. “Troublesome items” is used herein to refer to items of training data that prevent a decision tree ML algorithm from achieving full segmentation of its ruleset. “Segmentation” in the context of decision tree ML algorithms refers to the number of items within the training dataset per “leaf” of rulesets generated by training the decision tree ML algorithm. A leaf refers to a unique suite of features of an item in the training data that justifies a labelling designation. A “fully-segmented ruleset has only one training dataset item satisfying any given leaf.

As can be observed from unmodified training dataset 220, unmodified item 3 can be identified as a troublesome item because it contains identical features and labeling as unmodified item 2. No set of rules can distinguish unmodified item 3 from unmodified item 2, therefore one of them must be removed in order to have only one item of training data associated with any leaf of a generated ruleset. Similarly, unmodified item 9 can be identified as a troublesome item because it contains identical features as unmodified item 8, but with different labeling. No consistent set of rules can distinguish unmodified item 9 from unmodified item 8, therefore one of them must be removed in order to have only one item of training data associated with any leaf of a generated ruleset. One of unmodified items 2 and 3, as well as one of unmodified items 8 and 9 must be removed from unmodified training dataset 230 in order for a fully segmented ruleset to be generated from the remaining training dataset.

FIG. 2B illustrates a training dataset 230. As can be seen from the illustration, training dataset 230 was generated by removing unmodified items 3 and 9 from the unmodified training dataset 220, and renumbering the items. Because training dataset 230 contains no troublesome items, training dataset 230 may be used to train a decision tree ML algorithm to generate a fully segmented ruleset. In examples where a training dataset is received which contains no troublesome items without being modified, the received training dataset may be used to train a decision tree ML algorithm to generate a fully segmented ruleset without modification. Training datasets 220 and 230 were supplied with arbitrary values for the features, generated for illustration purposes only. The values do not represent any real world measurements conducted by applicant.

FIG. 2C illustrates a fully segmented decision tree ruleset 200 as may be generated by training a decision tree ML algorithm with training dataset 230. The depicted tree describes a ruleset, wherein the ruleset can be understood by following a pathway through the decision tree ruleset 200 to a terminating “leaf node” (denoted as rectangular nodes in the disclosed decision tree ruleset e.g., 210, 212). Following this pathway will result in filtering a given item of test data into a leaf node wherein the unique suite of features associated with the leaf that justifies the applying the label indicated at the leaf to the given item of test data. Starting at the top node 202, a series of rules is generated by following the tree branches down until reaching a leaf node. Each node of the decision tree may test data on a number of features. In the disclosed example, each node of the decision tree tests traffic flow metadata on only one feature at a time.

In the disclosed example, the traffic flow metadata is tested according to the following features: mean_pklt—the mean length of packets in the traffic data flow, min_pklt—the minimum length of packets in the traffic data flow, intr_arrvl_t—inter packet arrival time, xfer_rate—packet transfer rate, pkt_vol—packet volume, and total_pkts—total transferred packets. Where a leaf node is described as having members herein, this is understood to refer to the training or test dataset items containing the unique suite of features associated with the leaf. Items 1-10 of the training dataset 230 are indicated near each of their associated leaf nodes. As can be seen from the illustrated tree, only one item of training data is associated with each leaf node of the fully-segmented decision tree ruleset 200. This is the hallmark of a fully-segmented decision tree ruleset.

All items of test data, i.e. new traffic flow features measured at the deploying devices, matching a leaf node are given the labeling listed at the leaf. For instance, by following the path through nodes 202, 204, 206, 208, and finally 210, leaf 210 is understood to contain all items of the test data having mean_pklt>475.202, intr_arrvl_t>587.774, mean_pklt≤608.594, and total_pkts≤2, with all such items receiving the label “Non-benign”.

The traffic flows are classified as either benign or non-benign according to fully-segmented ruleset 200, wherein benign indicates the traffic flow did not originate from malware, and non-benign indicates the traffic flow did originate from malware. In other examples, a decision tree may derive a ruleset based on a training dataset regarding any type of data having any type and/or number of criteria, with the ruleset classifying the training dataset into any important classification scheme. The remaining traffic flows may be classified as non-benign or benign depending on features tested at other branches of the ruleset 200.

As a person of skill in the art recognizes, the decision tree ruleset 200 may be generated in different ways. The general structure and complexity of the decision tree may be dictated by hyperparameters. In some examples, a hyperparameter regarding the max depth of the tree may be used, wherein the number of decision nodes to get to any given leaf node is limited. To aid in understanding, the depth of the disclosed decision tree ruleset 200 is 4-via decision node 202, 204, 206, and 208. In some examples, a hyperparameter regarding the leaf size of the tree may be used, wherein the number of members of training data items at a leaf node is limited. For reasons discussed above regarding the desirability of fully segmented rulesets in the context of classifying traffic flows according to maliciousness, the leaf size of the decision tree ruleset 200 may be thought of as limited to a maximum of 1. In some examples a hyperparameter regarding the maximum/minimum number of features may be used, wherein the number of features considered at any node conditional is limited. To aid in understanding, the features limit of the disclosed decision tree is 1-only one feature is considered at each node.

Fully segmented decision tree ruleset 200 for the present disclosure has a maximum leaf size of 1. This means that for the ML algorithm employed to generate decision tree ruleset 200, hyperparameters are set such that the decision tree generated will keep adding decision nodes until only one item of the training set data occupies each leaf node. As discussed above, this configuration of hyperparameters is avoided in common ML practice as being “over-fitted” to the training data. In the context of the present disclosure, however, circumstances are contemplated wherein training data is likely to have fine detail patterns which may be more identifiable by an over-fitted (i.e. fully segmented) model.

FIG. 3 illustrates an example generating device 300 employing systems and methods to classify traffic flows across a network according to a fully segmented model. Generating device 300 includes hardware processors 302. In various examples, hardware processors 302 may include one or more processors. In the disclosed example generating device 300 is contemplated as being a data center 102. In some examples, an edge switch 106, distribution switch 104, end user device 108, or any device capable of communicating with a networked device may instead act as generating device 300 by employing the same or similar methods as those disclosed herein. The disclosed methods are provided for illustrative purposes only and should not be interpreted as limiting the scope of the technology to only the depicted operations.

Hardware processors 302 are configured to execute instructions stored on a machine-readable medium 304. Machine-readable medium 304 may be one or more types of non-transitory computer storage mediums. Non-limiting examples include: flash memory; solid state storage devices (SSDs); a storage area network (SAN); removable memory (e.g., memory stick, CD, SD cards, etc.); or internal computer RAM or ROM; among other types of computer storage mediums. The instructions stored on the machine-readable medium 304 may include various sub-instructions for performing the disclosed operations. Further, where operations are illustrated with a dashed line box instead of a solid line box, such operations are optional. In some examples, none of the operations illustrated with dashed line boxes are executed. In some examples, one or more of the operations illustrated with dashed line boxes are executed. In some examples, all of the operations illustrated with dashed line boxes are executed.

At operation 306, a training dataset is received by the generating device 300. In some examples, the training dataset may be input by a user directly interfacing with the data center via an input device like a mouse and keyboard. In some examples, the training dataset may be received over a network interface from a device remote from the generating device 300. In the disclosure herein the received training dataset pertains to a collection of traffic flow metadata labeled according to the traffic flow's maliciousness (e.g. benign vs. non-benign). However, in other examples the received training dataset may pertain to any labeling/classification system applicable to data available at a deploying device.

At operation 308, problematic items within the training dataset are identified and removed. “Problematic items” in the disclosure herein refers to items within the training dataset having features preventing or impeding the generation of a fully segmented ruleset when the training dataset is used to train a decision tree ML algorithm. An example of “problematic items” may include two items contain identical features but are pre-labeled with different labels. Another example of “problematic items” may include “duplicates” where two items in the training set data have the same features and the same labeling. FIGS. 2A-B illustrate examples of problematic items in a training dataset. Where features between two items in the training dataset are identical, the generation of a fully segmented ruleset from the training dataset may be prevented, as no rule or series of rules based on the features can logically separate the two items into individual leaf nodes. After these problematic items are removed from the training dataset, the decision tree ML algorithm may be trained with the training dataset to generate a fully segmented ruleset. In some examples, the problematic items are displayed to a user, such that the user is informed that the problematic items are being deleted. In some examples, the problematic items are displayed to a user, such that the user may provide input preventing one or more of the problematic items from being removed from the training dataset.

At operation 310, the decision tree ML algorithm is trained with the training dataset to generate a fully segmented decision tree ruleset. In some examples, the decision tree ML algorithm's hyperparameters are tuned such that each leaf of the first decision tree ruleset contains only one item of training set data (i.e. the decision tree ruleset is fully segmented). A fully segmented decision tree ruleset is illustrated and described in further detail in relation to FIGS. 2A-C above. In some examples, a user may be presented with an interface to customize the decision tree ML algorithm's hyperparameters. In some examples, when a decision tree ruleset is generated that is not fully segmented, a user may be provided with an option to continue with a non-fully segmented ruleset.

At operation 312, options are presented to a user (e.g. an admin user) for flagging strategies to be deployed at the deploying device and tolerance thresholds to be applied to flagged traffic flows. In some examples, flagging strategies comprise indicating flag leaf nodes such that all network traffic flows with features matching the suite of features associated with the flag leaf node are designated for classification at the generating device 300. Such flagging strategies may be chosen, e.g., wherein a problematic item was previously removed, such that a flag leaf node may be indicated where the removed problematic item contained features satisfying the complete rule pathway to the flag leaf node. Tolerance thresholds relate to classifications at the generating device 300 after the flagged network traffic flows returned, and are discussed in more detail below relating to operation 320.

At operation 314, the selected flagging strategies and/or tolerance thresholds are received from the user. The user may have input their selections by directly interfacing with the generating device 300 via an input device like a mouse and keyboard. In some examples, the selections may be received over a network interface from a device remote from the generating device 300. In some examples, operations 308 and/or 310 are fully or partially automated, such that a user is not required to do parts of operations 308 and/or 310. For instance, instead of displaying flagging strategy options for the user, a processor 302 at the generating device 300 may automatically pick a flagging strategy. After receiving the selected flagging strategies and/or tolerance thresholds, the received flagging strategies and/or tolerance thresholds are sent to the deploying device. In some examples the deploying device is the same device as the generating device 300. In some examples, sending the flagging strategy comprises sending machine readable instructions over a network interface to the deploying device, wherein the machine readable instructions deploy the flagging strategy when executed at the deploying device.

At operation 316, the fully segmented decision tree ruleset is sent to the deploying device. In some examples the deploying device is the same device as the generating device 300. In some examples, sending the decision tree ruleset comprises sending machine readable instructions over a network interface to the deploying device, wherein the machine readable instructions deploy the decision tree ruleset when executed at the deploying device.

At operation 318, classified network traffic flow metadata is received from the deploying device. In examples where the generating device is the deploying device, the classified network traffic flow metadata is called from a machine readable medium at the generating device.

At operation 320, flagged metadata is received from the deploying device and the flagged metadata is compared with an unmodified version training dataset of the training dataset to classify the associated network traffic flow data. In some examples examples, a separate device may execute operation 320. In examples where the generating device is the deploying device, the flagged metadata is called from a machine readable medium at the generating device. The comparison between the flagged metadata and the unmodified version of the training dataset is carried out by comparing the features of the flagged metadata with the features of items of the unmodified version of the training dataset. The unmodified version of the training dataset in the disclosure herein refers to a version of the training dataset with before removing any problematic items..

In some examples, comparing features of the flagged metadata with features of items of the original training dataset comprises measuring the difference between the values for a feature shared between the flagged metadata and the item of the original training dataset. Where the difference is below the tolerance threshold, the flagged network traffic flow may be labeled with the label applied to the closest item of the training dataset. Where the difference is above the tolerance threshold, the flagged network traffic flow data may be labeled as “unknown”. In some examples, multiple features may be compared simultaneously based on a Euclidean distance between the multiple features of the flagged metadata and the multiple features of the closest item of the training dataset. In such examples, the Euclidean distance is compared with the tolerance threshold. In some examples the tolerance threshold may have been previously selected by a user at operation 312. In the disclosure herein, a tolerance threshold of zero is referred to as “zero trust”, while a non-zero tolerance threshold is referred to as “flexible trust”.

At operation 322, the classified network traffic flow metadata is supplied to an admin user to assist the user in managing the network. The classified network traffic flow metadata may include traffic flows classified by the flagging strategy above. In some examples, supplying the classified network traffic flow metadata comprises displaying the metadata to the admin user via a user interface provided at the generating device. In some examples, supplying the classified network traffic flow metadata comprises transmitting the metadata over the network to a remote device operated by the admin user. The classified network traffic flow metadata assists the admin user in managing the network by providing more accurate labeling to the traffic flows propagating across the network, at least in the context of labeling the traffic flows according to maliciousness. With the disclosed systems and methods, management of the network may improve via e.g., quicker monitoring, more responsive security, more efficient traffic flow prioritization.

FIG. 4 illustrates an example deploying device 400 employing systems and methods to classify traffic flows across a network according to a fully segmented model. Deploying device 400 includes hardware processors 402. In various examples, hardware processors 402 may include one or more processors. In the disclosed example deploying device 400 is contemplated as being a edge switch 106. In some examples, a data center 102, distribution switch 104, end user device 108, or any device capable of communicating with a networked device may act as deploying device 400 by employing methods the same or similar to the disclosed methods. The deploying device 400 is disclosed utilizing a received fully segmented decision tree ruleset to classify traffic flows passing through the deploying device 400. The disclosed methods are provided for illustrative purposes only and should not be interpreted as limiting the scope of the technology to only the depicted operations.

Hardware processors 402 are configured to execute instructions stored on a machine-readable medium 404. Machine-readable medium 404 may be one or more types of non-transitory computer storage mediums. Non-limiting examples include: flash memory; solid state storage devices (SSDs); a storage area network (SAN); removable memory (e.g., memory stick, CD, SD cards, etc.); or internal computer RAM or ROM; among other types of computer storage mediums. The instructions stored on the machine-readable medium 404 may include various sub-instructions for performing the disclosed operations. Further, where operations are illustrated with a dashed line box instead of a solid line box, such operations are optional. In some examples, none of the operations illustrated with dashed line boxes are executed. In some examples, one or more of the operations illustrated with dashed line boxes are executed. In some examples, all of the operations illustrated with dashed line boxes are executed.

At operation 406, a fully segmented decision tree ruleset is received by the deploying device. In some examples, the fully segmented decision tree ruleset may instead be input by a user directly interfacing with the deploying device via an input device like a mouse and keyboard. In some examples, the decision tree ruleset may be received over a network interface from a device remote from the deploying device. In examples where the deploying device is the generating device, the fully segmented decision tree ruleset may be instead read from a machine readable medium at the deploying device. A fully segmented decision tree ruleset is illustrated and described in further detail in relation to FIGS. 2A-C above.

At operation 408, a flagging strategy is received by the deploying device and applied to network traffic flows in order to flag network traffic flows. In some examples, the flagging strategy may instead be input by a user directly interfacing with the deploying device via an input device like a mouse and keyboard. In some examples, the flagging strategy may be received over a network interface from a device remote from the deploying device. In examples where the deploying device is the generating device, the flagging strategy may be instead read from a machine readable medium at the deploying device. The flagging strategy is applied by flagging network traffic flows containing features designated in the flagging strategy as requiring classification via complex methods. Such complex methods may be completed at a generating node containing more computing resources.

At operation 410, the decision tree ruleset is applied to classify network traffic flow data. The decision tree ruleset is applied to classify network traffic flow data by applying the comparisons present at a given node to a given traffic flow's features until reaching a leaf node. Once a leaf node is reached, the traffic flow is classified by giving it the label at the leaf node.

At operation 412, a flagged metadata associated with the flagged network traffic flows is generated. In some examples, the flagged metadata is generated by creating metadata indicating the features of the flagged network traffic flow, and concatenating an additional feature to the metadata indicating that the associated network traffic flow was flagged. In some examples, the flagged metadata is only an identification of the flagged traffic flow by reference or pointer.

At operation 414, a classified network traffic flow metadata is generated based on the features and classification of network traffic flow data. In some examples, the classified network traffic flow metadata is generated by creating metadata indicating the features of the flagged network traffic flow, and concatenating a label to each item of the traffic flow metadata, wherein the label corresponds to the classification. In some examples, the label is associated to an item of traffic flow via an identification of the traffic flow by reference or pointer.

At operation 416, the flagged metadata is sent to the generating device. In the disclosure herein, the network device receiving the flagged metadata is the generating device. In some examples the network device receiving the flagged metadata is not the generating device. In some examples, the network device receiving the flagged metadata is the deploying device, with the flagged metadata being stored at a machine-readable storage media 404.

At operation 418, metadata associated with classified network traffic flows is sent to the generating device. In the disclosure herein, the network device receiving the classified network traffic flows is the generating device. In some examples the network device receiving the classified network traffic flows is not the generating device. In some examples, the network device receiving the classified network traffic flows is the deploying device, with the classified network traffic flows being stored at a machine-readable storage media 404.

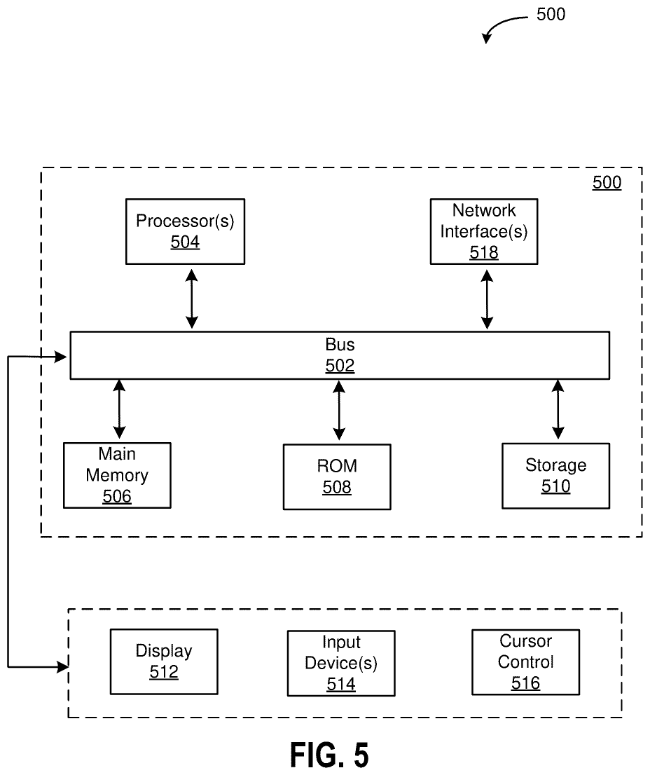

FIG. 5 depicts a block diagram of an example computer system 500 in which various of the examples described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some examples, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one example, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of classifying network traffic flows across a network for improved network management by a user, the method comprising:
receiving, at a first network device connected to the network, a training dataset;
training a decision tree machine learning (“ML”) algorithm with the training dataset, resulting in the generation of a fully segmented ruleset comprising a plurality of leaf nodes, each leaf node of the fully segmented ruleset being associated with at least one feature in the training dataset, and each item of the training dataset having a combination of features matching a different leaf node of the fully segmented ruleset from all other items of the training dataset;
sending the fully segmented ruleset to a second network device connected to the network;
receiving, at the first network device, a classified network traffic flow metadata from the second network device; and
supplying the classified network traffic flow metadata to a user, wherein the classified network traffic flow metadata assists the user in managing the network.

2. The method of claim 1, the method further comprising, before training the decision tree ML algorithm, adjusting hyperparameters associated with the decision tree ML algorithm, the adjustments reducing the maximum number of items of training data sharing a combination of features matching one leaf node of any ruleset generated by the decision tree ML algorithm.

3. The method of claim 1, the method further comprising, before supplying the classified network traffic flow metadata to the user:
displaying a flagging strategy to the user, the flagging strategy comprising methods for designating a network traffic flow for classification at the first device;
receiving a selection from the user indicating the flagging strategy;
sending the flagging strategy to the second network device;
receiving flagged metadata relating to a designated network traffic flow from the second network device;
comparing the flagged metadata with an item of the training dataset;
classifying the designated network traffic flow based on the comparison of the flagged metadata with the item of the training dataset;
updating the flagged metadata with the classification applied to the designated network traffic flow; and
incorporating the updated flagged metadata with the classified network traffic flow metadata.

4. The method of claim 3, further wherein the flagging strategy comprises indicating a flag leaf node, wherein all network traffic flows having a combination of features matching the flag leaf node are designated for classification at the first device.

5. The method of claim 3, the method further comprising, before supplying the classified network traffic flow metadata to the user:
displaying a tolerance threshold to the user, the tolerance threshold relating to a difference calculated when comparing the flagged metadata with the item of the training dataset;
receiving a second selection from the user indicating the tolerance threshold;
where the difference exceeds the tolerance threshold, classifying the designated network traffic flow associated with the flagged metadata as unknown; and
where the difference does not exceed the tolerance threshold, classifying the designated network traffic flow associated with the flagged metadata according to a label applied to the item of the training dataset.

6. The method of claim 5, further wherein:
comparing the flagged metadata with the item of the training dataset comprises calculating a Euclidean distance based on a plurality of features,
both the flagged metadata and item of the training dataset have values for each feature of the plurality of features; and
the difference is the Euclidean distance.

7. The method of claim 1, the method further comprising, before training the decision tree ML algorithm:
identifying a problematic item in the training dataset, wherein the problematic item impedes the generation of rulesets having each item of the training dataset comprising a combination of features matching a different leaf node of the ruleset from all other items of the training dataset; and
modifying the training dataset by removing the problematic item from the training dataset.

8. The method of claim 7, the method further comprising, before supplying the classified network traffic flow metadata to the user:
displaying a flagging strategy to the user, the flagging strategy comprising methods for designating a network traffic flow for classification at the first device;
receiving a selection from the user indicating the flagging strategy;
sending the flagging strategy to the second network device;
receiving flagged metadata relating to a designated network traffic flow from the second network device;
before comparing the flagged metadata with an item of the training dataset, modifying the training dataset by adding the problematic item to the training dataset;
classifying the designated network traffic flow based on the comparison of the flagged metadata with the item of the training dataset;
updating the flagged metadata with the classification applied to the designated network traffic flow; and
incorporating the updated flagged metadata with the classified network traffic flow metadata.

9. The method of claim 8, further wherein the flagging strategy comprises selecting a flag leaf node, wherein all network traffic flows having a combination of features matching the flag leaf node are designated for classification at the first device.

10. The method of claim 9, further wherein the flag leaf is selected because the problematic item has a combination of features matching the flag leaf node.

11. The method of claim 8, the method further comprising, before supplying the classified network traffic flow metadata to the user:
displaying a tolerance threshold to the user, the tolerance threshold relating to a difference calculated when comparing the flagged metadata with the item of the training dataset;
receiving a second selection from the user indicating the tolerance threshold;
where the difference exceeds the tolerance threshold, classifying the designated network traffic flow associated with the flagged metadata as unknown; and
where the difference does not exceed the tolerance threshold, classifying the designated network traffic flow associated with the flagged metadata according to a label applied to the item of the training dataset.

12. The method of claim 11, further wherein:
comparing the flagged metadata with the item of the training dataset comprises calculating a Euclidean distance based on a plurality of features,
both the flagged metadata and item of the training dataset have values for each feature of the plurality of features; and
the difference is the Euclidean distance.

13. A method of classifying network traffic flows across a network for improved network management by a user, the method comprising:
receiving, at a first network device connected to the network, a fully segmented ruleset, wherein:
the fully segmented ruleset was generated by training a decision tree machine learning (“ML”) algorithm with a training dataset; and
each item of the training dataset has a combination of features matching a different leaf node of the fully segmented ruleset from all other items of the training dataset;
classifying a network traffic flow by comparing features of the network traffic flow against features tested in the fully segmented ruleset and applying a label at a leaf node of the fully segmented ruleset;
generating a classified network traffic flow metadata associated with the classified network traffic flow, the classified network traffic flow metadata comprising the features of the network traffic flow and the classification of the network traffic flow; and
sending the classified network traffic flow metadata to a second network device connected to the network.

14. The method of claim 13, the method further comprising:
receiving, at the first network device, a flagging strategy comprising methods for designating a network traffic flow for classification at the second device;
applying the flagging strategy to the network traffic flow to designate the network traffic flow for classification at the second device;
generating a flagged metadata associated with the designated network traffic flow, the flagged metadata comprising the features of the network traffic flow and the designation of the network traffic flow for classification at the second device; and
sending the flagged metadata to the second network device.

15. The method of claim 14, further wherein applying the flagging strategy to the network traffic flow to designate the network traffic flow for classification at the second device comprises:
designating the network traffic flow for classification at the second device because the network traffic flow has a combination of features matching a flag leaf node, wherein the flag leaf node was indicated within the flagging strategy.

16. A non-transitory computer-readable medium having instructions stored therein, which when executed by a processor cause the processor to perform operations, the operations comprising:
receiving, at a first network device connected to the network, a training dataset;
identifying a problematic item in the training dataset, wherein the problematic item impedes the generation of rulesets wherein each item of the training dataset has a combination of features matching a different leaf node of the ruleset from all other items of the training dataset;
modifying the training dataset by removing the problematic item from the training dataset;
training a decision tree machine learning (“ML”) algorithm with the training dataset, resulting in the generation of a fully segmented ruleset comprising a plurality of leaf nodes, each leaf node of the fully segmented ruleset being associated with at least one feature in the training dataset, and each item of the training dataset having a combination of features matching a different leaf node of the fully segmented ruleset from all other items of the training dataset;
sending the fully segmented ruleset to a second network device connected to the network;
sending a flagging strategy to the second network device, the flagging strategy comprising methods for designating a network traffic flow for classification at the first device;
receiving, at the first network device, a classified network traffic flow metadata from the second network device;
receiving flagged metadata relating to a designated network traffic flow from the second network device;
before comparing the flagged metadata with an item of the training dataset, modifying the training dataset by adding the problematic item to the training dataset;
classifying the designated network traffic flow based on the comparison of the flagged metadata with the item of the training dataset;
updating the flagged metadata with the classification applied to the designated network traffic flow;
incorporating the updated flagged metadata with the classified network traffic flow metadata; and
supplying the classified network traffic flow metadata to a user, wherein the classified network traffic flow metadata assists the user in managing the network.

17. The method of claim 16, further wherein the flagging strategy comprises selecting a flag leaf node, wherein all network traffic flows having a combination of features matching the flag leaf node are designated for classification at the first device.

18. The method of claim 17, further wherein the flag leaf is selected because the problematic item has a combination of features matching the flag leaf node.

19. The method of claim 16, further the method further comprising, before supplying the classified network traffic flow metadata to the user:
determining a tolerance threshold relating to a difference calculated when comparing the flagged metadata with the item of the training dataset;
where the difference exceeds the tolerance threshold, classifying the designated network traffic flow associated with the flagged metadata as unknown; and
where the difference does not exceed the tolerance threshold, classifying the designated network traffic flow associated with the flagged metadata according to a label applied to the item of the training dataset.

20. The method of claim 19, further wherein:
comparing the flagged metadata with the item of the training dataset comprises calculating a Euclidean distance based on a plurality of features,
both the flagged metadata and item of the training dataset have values for each feature of the plurality of features; and
the difference is the Euclidean distance.
